(19) United States
(12) Patent Application Publication
(10) Pub. No.: US 2024/0229983 A9
(43) Pub. Date: Jul. 11, 2024

(54) WELDING PROCESS FOR SIDE POCKET MANDREL

(71) Applicant: Baker Hughes Oilfield Operations LLC, Houston, TX (US)

(72) Inventors: Tuan Tran, Houston, TX (US); Donavan Brown, Houston, TX (US)

(73) Assignee: Baker Hughes Oilfield Operations LLC, Houston, TX (US)

(21) Appl. No.: 18/379,137

(22) Filed: Oct. 11, 2023

Related U.S. Application Data
(60) Provisional application No. 63/417,685, filed on Oct. 19, 2022.

(51) Int. Cl. F16L 13/02; E21B 17/04

(52) U.S. Cl. CPC F16L 13/02; E21B 17/04; E21B 43/123

(57) ABSTRACT

In one aspect, embodiments of the present disclosure are directed to a process for manufacturing a side pocket mandrel that involves welding upper and lower swages to a central body of the side pocket mandrel. In some embodiments, the process includes the steps of providing a first side of the welded joint and a second side of the welded joint, where the first and second sides are either the central body or the swage. The process continues with the step of approximating the first and second sides such that the first and second sides are in contact. Importantly, the first and second sides are brought together without creating a root gap between the first and second sides. Next, the first and second sides are welded together to form the welded joint between the swage and the central body.

### RELATED APPLICATIONS

The present application claims the benefit of U.S. Provisional Patent Application Ser. No. 63/417,685 filed Oct. 19, 2022 and entitled “Welding Process for Side Pocket Mandrel,” the disclosure of which is herein incorporated by reference.

### FIELD OF THE INVENTION

This invention relates generally to the field of oil and gas production, and more particularly to an improved method for manufacturing side pocket mandrels used in gas lift systems.

### BACKGROUND

Gas lift is a technique in which gaseous fluids are injected into the tubing string to reduce the density of the produced fluids to allow the formation pressure to push the less dense mixture to the surface. In annulus-to-tubing systems, pressurized gases are injected from the surface into the annulus, where the pressurized gases enter the tubing string through a series of gas lift valves. Alternatively, in tubing-to-annulus systems, pressurized gases are injected into the tubing string and discharged into the annulus, where the gases help to produce fluids out of the annulus. A series of gas lift valves allow access from the annulus into the production tubing or from the production tubing into the annulus. The gas lift valves can be configured to automatically open when the pressure gradient between the annulus and the production tubing exceeds the closing force holding each gas lift valve in a closed position.

To permit the unimpeded production of wellbore fluids through the production tubing, the gas lift valves are housed within “side pocket mandrels” that include a valve pocket (or side pocket tube) that is laterally offset from the production tubing. Because the gas lift valves are contained in these laterally offset valve pockets, tools can be deployed and retrieved through the open primary passage (central bore) of the side pocket mandrel. The predetermined position of the gas lift valves within the production tubing string controls the entry points for gas into the production string.

The side pocket mandrel generally has a central body with a cross-sectional area that is sufficiently large to include the internal valve pocket that is laterally offset from the central bore in coaxial alignment with the production tubing. The central body can have a circular or oval cross-sectional shape. Upper and lower swages connect the central body to the adjacent joints of production tubing.

The upper and lower swages are typically connected to the central body with a welding process. Standard welding methodologies for side pocket mandrels call for the use of a traditional fillet weld shoulder and a root gap between the swage and the central body. These welds required a gas-shielded “root pass” and several subsequent filler passes to fill the body thickness. In many cases, the root pass is made with a gas metal arc welding (GMAW) process, followed by a number of flux-cored welding arc (FCAW) filler passes. The conventional welding process is complicated and time consuming. In some cases, the welding process takes one to two hours to complete. There is, therefore, a need for an improved process for joining the upper and lower swage sections to the central body of the side pocket mandrel. It is to these and other deficiencies in the prior art that the present disclosure is directed.

### SUMMARY OF THE INVENTION

In one aspect, embodiments of the present disclosure are directed to a process for manufacturing a side pocket mandrel that involves welding upper and lower swages to a central body of the side pocket mandrel. In some embodiments, the process includes the steps of providing a first side of the welded joint and a second side of the welded joint, where the first and second sides are either the central body or the swage. The process continues with the step of approximating the first and second sides such that the first and second sides are in contact. Importantly, the first and second sides are brought together without creating a root gap between the first and second sides. Next, the first and second sides are welded together to form the welded joint between the swage and the central body. The elimination of the root gap and the need for shielding gases reduces the time required to successfully join the upper and lower swages to the central body, while improving the consistency and quality of the resulting welded joints.

In other embodiments, the present disclosure is directed to a two-component assembly that includes a swage and central portion that are configured to be connected together with a welded joint. The two component assembly includes a first side and a second side, where the first side is either the swage or the central portion, and the second side is the swage if the first side is the central portion and where the second side is the central portion if the first side is the swage.

In yet other embodiments, the present disclosure is directed to a process for creating a welded joint between a swage and a central body of a side pocket mandrel. In these embodiments, the method includes the steps of providing a first side of the welded joint, where the first side is the central body, providing a second side of the welded joint, where the second side is the swage, and approximating the first and second sides such that the first and second sides are in contact without a root gap. The process continues with the steps of performing a root pass weld between the first and second sides, and then performing one or more filler welds on top of the root pass weld to complete the welded joint between the swage and the central body.

### BRIEF DESCRIPTION OF THE DRAWINGS

FIG. 1 is a schematic of a gas lift system constructed in accordance with an exemplary embodiment deployed in a wellbore.

FIGS. 2A and 2B depict side and cross-sectional views of exemplary side pocket mandrels constructed according to the embodiments disclosed herein.

FIGS. 3A-3D depict cross-sectional views of the swage-to-body joint constructed and welded in accordance with a first embodiment.

FIGS. 4A-4D depict cross-sectional views of the swage-to-body joint constructed and welded in accordance with a second embodiment.

FIGS. 5A-5D depict cross-sectional views of the swage-to-body joint constructed and welded in accordance with a third embodiment.

FIGS. 6A-6D depict cross-sectional views of the swage-to-body joint constructed and welded in accordance with a fourth embodiment.

### WRITTEN DESCRIPTION

As used herein, the term “petroleum” refers broadly to all mineral hydrocarbons, such as crude oil, gas and combinations of oil and gas. The term “fluid” refers generally to both gases and liquids, and “two-phase” or “multiphase” refers to a fluid that includes a mixture of gases and liquids. “Upstream” and “downstream” can be used as positional references based on the movement of a stream of fluids from an upstream position in the wellbore to a downstream position on the surface. Although embodiments of the present invention may be disclosed in connection with a conventional well that is substantially vertically oriented, it will be appreciated that embodiments may also find utility in horizontal, deviated or unconventional wells.

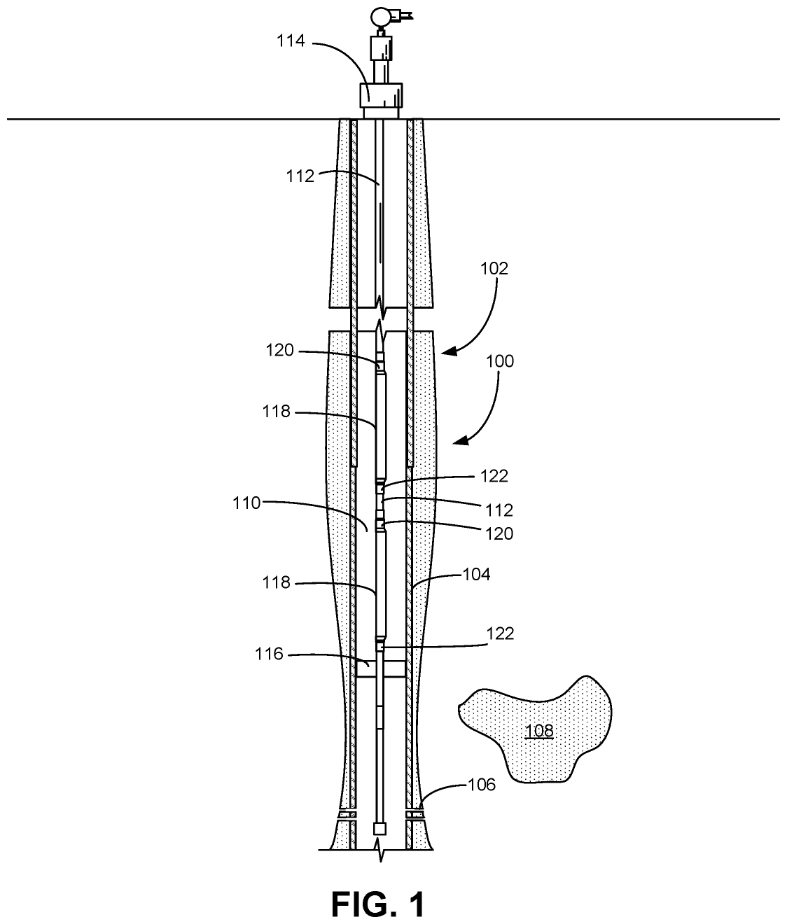

Turning to FIG. 1, shown therein is a gas lift system 100 disposed in a well 102. The well 102 includes a casing 104 and a series of perforations 106 that admit wellbore fluids from a producing geologic formation 108 through the casing 104 into the well 102. An annular space 110 is formed between the gas lift system 100 and the casing 104. The gas lift system 100 is connected to production tubing 112 that conveys produced wellbore fluids from the formation 108, through the gas lift system 100, to a wellhead 114 on the surface. In the embodiment depicted in FIG. 1, a packer 116 or other zonal isolation device has been placed between the perforations 106 and the gas lift system 100. It will be appreciated that FIG. 1 is intended to simply provide context for a deployment of the gas lift system 100 and should not be construed as a limiting expression of the various embodiments in which a gas lift system 100 can be deployed.

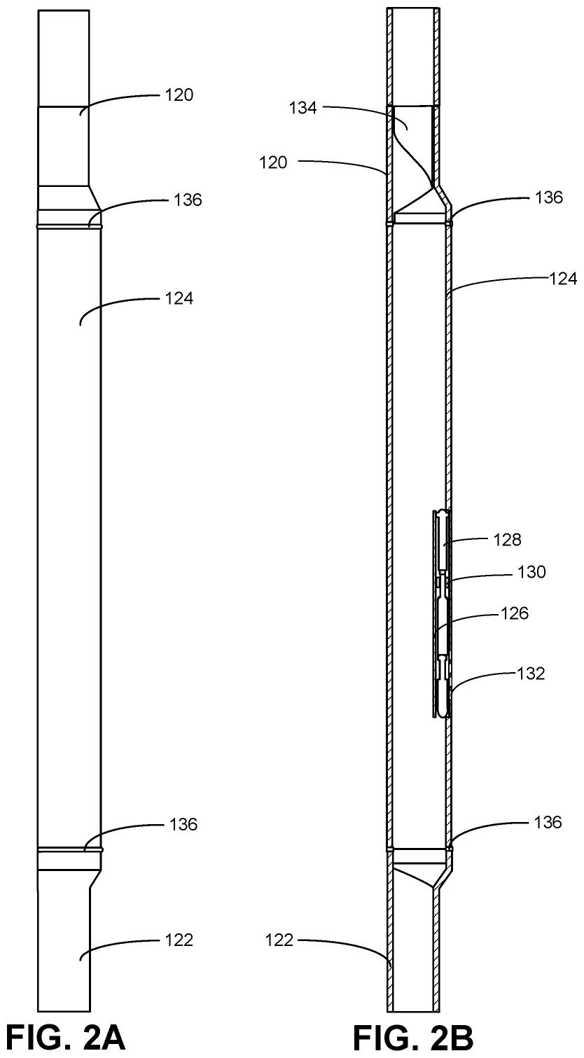

The gas lift system 100 also includes one or more side pocket mandrels 118 connected in line with the production tubing 112 above the packer 116. Turing to FIGS. 2A and 2B, shown therein are side and cross-sectional views, respectively, of the side pocket mandrel 118 constructed in accordance with exemplary embodiments. The side pocket mandrel 118 generally includes an upper swage 120 and a lower swage 122 on opposite sides of the side pocket mandrel 118. As used herein and in the appended claims, the isolated term “swage” refers to either of the upper and lower swages 120, 122. The side pocket mandrel 118 includes an enlarged central body 124 between the upper and lower swages 120, 122. As illustrated, the upper and lower swages 120, 122 provide a transition from the enlarged central body 124 to the smaller diameter of the adjacent production tubing 112. In some embodiments, the central body 124 has a round or oval cross-sectional shape.

The central body 124 has a larger diameter to accommodate the offset location a side pocket tube 126, which is configured to retain a gas lift valve 128. The side pocket tube 126 is laterally offset from a central bore that extends colinearly along the central longitudinal axis of the production tubing 112. It will be appreciated that the side pocket tube 126 includes a latch mechanism 130 that is designed to releasably retain the gas lift valve 128 or another downhole tool. Ports 132 extend through the outer wall of the central body 124 into the side pocket tube 126 to provide a path for fluids to move between the annular space 110 and the interior of the side pocket tube 126. A guide sleeve 134 can be located near or inside the upper swage 120 to facilitate the engagement and use of a kickover tool, which is designed to install and remove the gas lift valve 128 in the side pocket tube 126.

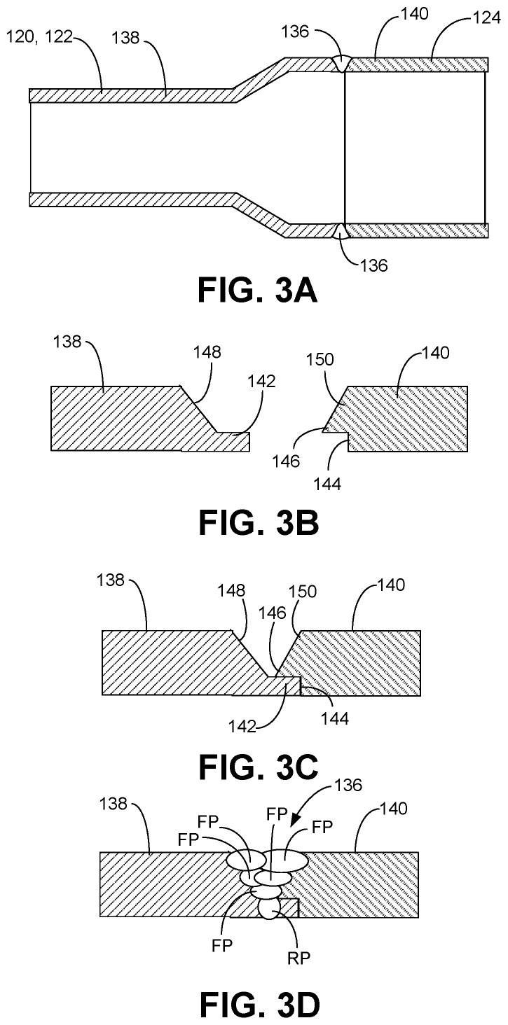

The upper and lower swages 120, 122 are connected to the central body 124 of the side pocket mandrel 118 with welded joints 136. The welded joints 136 are designed to provide a structural, sealed connection between the upper and lower swages 120, 122 and the central body 124 of the side pocket mandrel 118. Various methods for constructing the welded joints 136 are illustrated in FIGS. 3-6. In each case, the welded joint 136 includes a first side 138 and a second side 140, where the first side 138 and second side 140 can each be either one of the upper or lower swages 120, 122, or the central body 124. In this way, the first and second sides 138, 140 together provide a two-component assembly that can be connected together by the welded joint 136 to form the side pocket mandrel 118. The first and second sides 138, 140 are tubular with an interior and an exterior. It will be further appreciated that a single side pocket mandrel 118 can include a combination of different forms of welded joints 136. For example, the side pocket mandrel 118 can include a welded joint 136 of a first embodiment between the upper swage 120 and the central body 124 and a welded joint 136 of a second embodiment between the lower swage 122 and the central body 124.

FIGS. 3A-3D illustrate a first method of welding the upper and lower swages 120, 122 to the central body 124. In this embodiment, the first side 138 of the welded joint 136 includes a lower lip 142 and the second side 140 includes a matching recess 144 and nose 146. The first side 138 includes a first beveled face 148 that leads to the exterior side of the lip 142. The second side 140 includes a second beveled face 150 that transitions into the nose 146. When the first and second sides 138, 140 are connected, the intersection of the first beveled face 148 and the second beveled face 150 form an interior angle of between about 45° and 90°, with an optimal angle of about 60°. The first beveled face 148 and the second beveled face 150 may not directly contact one another such that a small portion of the lip 142 is exposed between the first beveled face 148 and the second beveled face 150.

As illustrated in FIGS. 3B and 3C, the lip 142 is captured within the recess 144 such that the nose 146 extends over a portion of the outer side of the lip 142. As best illustrated in FIG. 3A, the nose 146 on the central body 124 is configured to extend over the outside of the lip 142. This provides a structural connection between the upper or lower swage 120, 122 and the central body 124 that helps to align these components before the welding operation. Additionally, because the welded joint 136 does not include the typical root gap, a shielding gas is not required to be placed inside and later evacuated from the side pocket mandrel 118.

Once the central body 124 has been placed into registration with the upper or lower swages 120, 122, a first “root” welding pass can be made to secure the nose 146 to the lip 142. In some embodiments, welding flux paste can be added to the welded joint 136 to discourage oxidation. If external clamps are not used, tack welds can be used to secure the central body 124 to the upper or lower swages 120, 122. Once the parts are secured, the root pass (RP) can be made using a flux core arc welding (FCAW) process. The root pass can be made with the welder at between 160-240 amps at 26+ volts. After the root pass has been completed, the weld can be cleaned with a wire brush to remove slag and impurities. After the root pass has been cleaned, one or more filler passes (FP) can be made to fill the space between the first and second beveled faces 148, 150, as illustrated in FIG. 3D. Using this method and the novel configuration for the first and second sides 138, 140 of the welded joints 136, the entire welding process can take less than thirty (30) minutes, which represents a significant time savings over conventional welding methods.

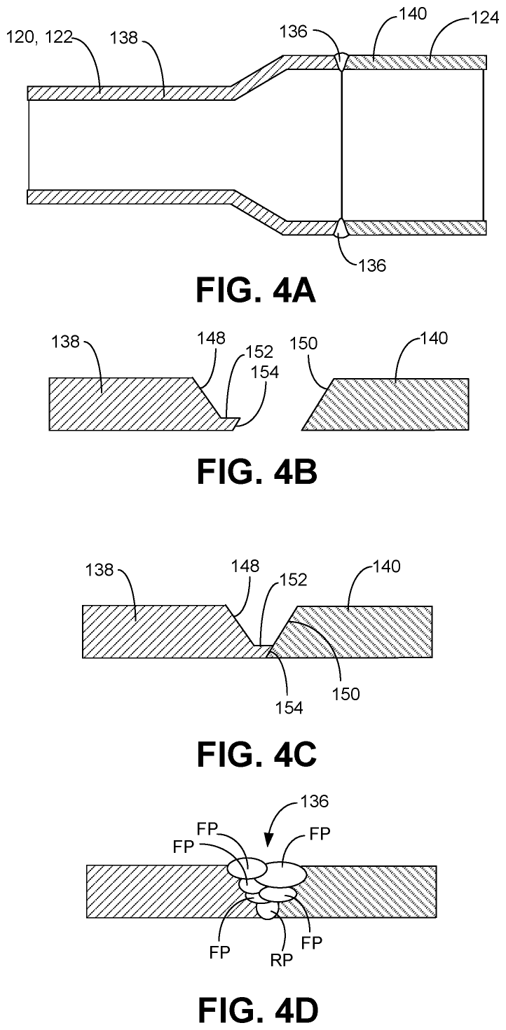

Turning to FIGS. 4A-4D, shown therein is a second method for welding the upper and lower swages 120, 122 to the central body 124. In this embodiment, the first side 138 includes a tongue 152 in place of the lip 142 and the second beveled face 150 does not include the recess 144 or nose 146. The tongue 152 includes an angled face 154 that congruently mates with an interior portion of the second beveled face 150. Because the tongue 152 mates with the second beveled face 150 to form a solid backing on the interior of the welded joint 136, it is not necessary to use an internal back purging gas.

Once the first and second sides 138, 140 have been secured together with clamps or tack welds, the root pass (RP) can be made using a flux core arc welding (FCAW) process. The root pass can be made with the welder at between 160-240 amps at 26+ volts. After the root pass has been completed, the weld can be cleaned with a wire brush to remove slag and surface impurities. After the root pass has been cleaned, one or more filler passes (FP) can be made to fill the space between the first and second beveled faces 148, 150, as illustrated in FIG. 4D. Using this method and the novel configuration for the first and second sides 138, 140 of the welded joints 136, the entire welding process can take less than thirty (30) minutes, which represents a significant time savings over conventional welding methods.

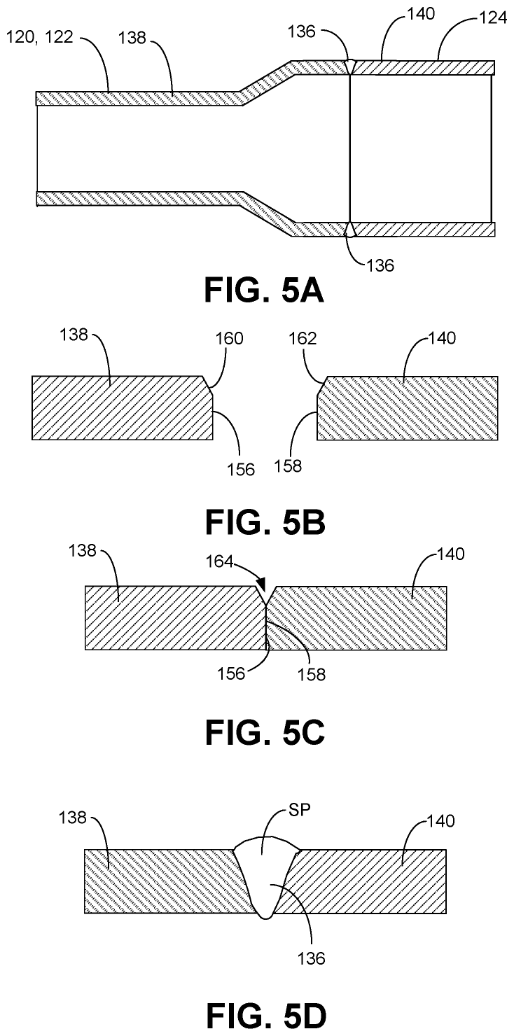

Turning to FIGS. 5A-5D, shown therein is a third method for welding the upper and lower swages 120, 122 to the central body 124. In this embodiment, the first and second sides 138, 140 are configured for a butt joint connection in which the first side 138 includes a first abutment face 156 and the second side 140 includes a second abutment face 158. The first abutment face 156 includes a first outer notch 160 and the second abutment face includes a corresponding second outer notch 162. When the first and second sides 138, 140 are approximated such that the first and second abutment faces 156, 158 are in tight contact, the first and second outer notches 160, 162 form an exterior V-shaped groove 164. In this way, the first and second sides 138, 140 are assembled together without a root gap such that there is no requirement for a back purging gas. Flux paste can be used on the abutting faces to mitigate oxidation.

Once the first and second sides 138, 140 have been placed in contact, a single welding pass (SP) can be used to create the welded joint 136. In exemplary embodiments, the single welding pass is made using a constricted plasma arc welding process (PAW) with a suitable inert shielding gas like argon or helium. In some applications, the welder can be operated at between 500 amps and 700 amps, at more than 30 volts. With this process, the welded joint 136 can be completed in less than 3 minutes without using a filler metal.

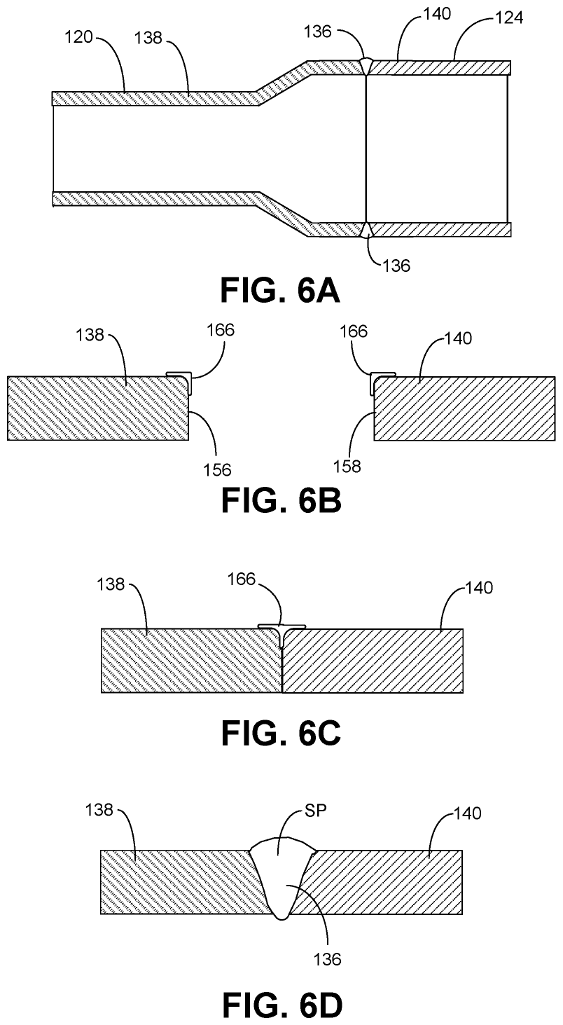

Turning to FIG. 6A-6D, shown therein are fourth and fifth methods for welding the upper and lower swages 120, 122 to the central body 124. In these embodiments, the first and second sides 138, 140 are configured for a butt joint connection in which the first abutment face 156 and second abutment face 158 do not include the first and second outer notches 160, 162, respectively. The first and second sides 138, 140 are approximated such that the first abutment face 156 presses against the second abutment face 158 in a tight butt joint that excludes notches or a root gap. In some embodiments, activated flux 166 can be placed on the first and second abutment faces 156, 158 and on the exposed exterior surfaces and abutment faces 156, 158 of the first and second sides 138, 140 (as depicted in FIGS. 6B and 6C).

Once the first and second sides 138, 140 have been placed in contact, with or without the activated flux 166, a single welding pass (SP) can be used to create the welded joint 136. In exemplary embodiments, the single welding pass is made using a constricted plasma arc welding process (PAW) with a suitable inert shielding gas like argon or helium. In some applications, the welder can be operated at more than 700 amps and more than 30 volts. With this process, the welded joint 136 can be completed in less than 3 minutes without using a filler metal.

Thus, the embodiments of the present disclosure depict various methods for welding the upper and lower swages 120, 122 to the central body 124 of the side pocket mandrel 118. The embodiments include welding methods and structural features on the first and second sides 138, 140 that eliminate the conventional use of a root gap and internal shielding gases. The elimination of the root gap and shielding gases reduces the time required to successfully join the upper and lower swages 120, 122 to the central body 124, while improving the consistency and quality of the welded joints 136.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A process for creating a welded joint between a swage and a central body of a side pocket mandrel, the method comprising the steps of:
providing a first side of the welded joint, wherein the first side is either the central body or the swage;
providing a second side of the welded joint, wherein the second side is either the central body or the swage and is different from the first side;
approximating the first and second sides such that the first and second sides are in contact without a root gap; and
welding the first and second sides together to form the welded joint between the swage and the central body.

2. The process of claim 1, wherein the step of providing the first side of the welded joint comprises providing a first side that includes:
a lip; and
a first beveled face.

3. The process of claim 2, wherein the step of providing the second side of the welded joint comprises providing a second side that comprises:
a second beveled face;
a recess configured for a mating engagement with the lip; and
a nose that is formed by the intersection of the recess and the second beveled face.

4. The process of claim 3, wherein the step of welding the first and second sides together to form the welded joint comprises:
making a root pass at the intersection of the lip, the first beveled face and the second beveled face; and
making one or more filler passes above the root pass between the first and second beveled faces.

5. The process of claim 1, wherein the step of providing the first side of the welded joint comprises providing a first side that includes:
a tongue that includes an angled face; and
a first beveled face.

6. The process of claim 5, wherein the step of providing the second side of the welded joint comprises providing a second side that comprises a second beveled face that is configured for a matched engagement with the angled face of the tongue.

7. The process of claim 6, wherein the step of welding the first and second sides together to form the welded joint comprises:
making a root pass at the intersection of the tongue, the first beveled face and the second beveled face; and
making one or more filler passes above the root pass between the first and second beveled faces.

8. The process of claim 1, wherein the step of providing the first side of the welded joint comprises providing a first side that includes:
a first abutment face; and
a first outer notch in the first abutment face.

9. The process of claim 8, wherein the step of providing the second side of the welded joint comprises providing a second side that includes:
a second abutment face; and
a second outer notch in the second abutment face.

10. The process of claim 9, wherein the step of welding the first and second sides together to form the welded joint comprises:
fitting the first and second sides together such that the first abutment face is in tight contact with the second abutment face and the first outer notch and second outer notch form a V-shaped groove between the first and second sides; and
making a single pass within the V-shaped groove.

11. The process of claim 1, wherein the step of providing the first side of the welded joint comprises providing a first side that includes a first abutment face.

12. The process of claim 11, wherein the step of providing the second side of the welded joint comprises providing a second side that includes a second abutment face.

13. The process of claim 12, wherein the step of welding the first and second sides together to form the welded joint comprises:
fitting the first and second sides together such that the first abutment face is in tight contact with the second abutment face; and
making a single pass at the intersection between the first side and the second side.

14. The process of claim 13, further comprising the step of applying activated flux paste to the intersection of the first and second sides before the step of making the single pass at the intersection between the first and second sides.

15. A two-component assembly comprising a swage and central portion that are configured to be connected together with a welded joint, wherein the two component assembly comprises:
a first side, wherein the first side is either the swage or the central portion; and
a second side, wherein the second side is the swage if the first side is the central portion and wherein the second side is the central portion if the first side is the swage.

16. The two-component assembly of claim 15, wherein the first side comprises:
a lip; and
a first beveled face extending away from the lip.

17. The two-component assembly of claim 16, wherein the second side comprises:
a nose;
a second beveled face extending away from the nose; and
a recess interior to the nose configured to receive the lip of the first side such that the nose rests on a portion of the lip and the first and second beveled faces extend away from one another.

18. The two-component assembly of claim 15, wherein the first side comprises:
a tongue that includes an angled face; and
a first beveled face extending away from the tongue.

19. The two-component assembly of claim 18, wherein the second side comprises a second beveled face that congruently mates with the angled face of the tongue of the first side.

20. A process for creating a welded joint between a swage and a central body of a side pocket mandrel, the method comprising the steps of:
providing a first side of the welded joint, wherein the first side is the central body;
providing a second side of the welded joint, wherein the second side is the swage;
approximating the first and second sides such that the first and second sides are in contact without a root gap; and
performing a root pass weld between the first and second sides; and
performing one or more filler welds on top of the root pass weld to complete the welded joint between the swage and the central body.
